(19) United States
(12) Patent Application Publication
(10) Pub. No.: US 2014/0082095 A1
(43) Pub. Date: Mar. 20, 2014

(54) WORKFLOW MONITORING

(71) Applicants: Helen Y. Balinsky, Bristol (GB); Steven J. Simske, Fort Collins, CO (US)

(72) Inventors: Helen Y. Balinsky, Bristol (GB); Steven J. Simske, Fort Collins, CO (US)

(21) Appl. No.: 13/621,449

(22) Filed: Sep. 17, 2012

(51) Int. Cl. G06F 15/16

(52) U.S. Cl. 709/206

(57) ABSTRACT

Systems, computer readable media, and methods for workflow monitoring of documents are provided. An example of a workflow monitoring system includes a document having a map-file for each participant in a workflow of the document and a first communication mechanism to transmit the document to a receiving participant in the workflow. The system includes an application, associated with a receiving device of the receiving participant, to extract a confirmation token from the map-file and transmit the confirmation token and a second communication mechanism, different from the first communication mechanism, to transmit a direct message including at least the confirmation token to verify receipt of the document by the receiving participant.

### BACKGROUND

Documents may be exchanged within and/or between organizations. Documents may be intended to be presented to a user (e.g., a participant) in an original form, such as one editable, browsable, approvable, playable document.

A document may be exported outside of a secured environment intended for receipt and/or use by an outside user. In some instances, the document may be re-imported back into the secured environment after being updated. When documents are distributed over non-secure channels, documents may become lost, for instance, by not being delivered to an intended recipient, and/or may be delivered but not in an authentic form.

### BRIEF DESCRIPTION OF THE DRAWINGS

FIG. 1 illustrates an environment in which various examples of workflow monitoring in accordance with the present disclosure may be implemented.

FIG. 2 is a block diagram of an example system for workflow monitoring according to the present disclosure.

### DETAILED DESCRIPTION

The present disclosure relates to workflow monitoring, for instance, of documents. Such documents may be distributed among dispersed participants by low-security communication mechanisms (e.g., transmitted/transferred by electronic mail (e-mail), cloud-based access, service- or shared-point access, being uploaded and/or downloaded, exchange of a compact disc (CD) and/or a digital versatile disc (DVD), through a universal serial bus (USB) and/or a shared drive, among other such low-security communication mechanisms).

Documents may have become a mixture, or a composite, of differentially formatted parts. Different parts may be combined together through various serialization mechanisms, such as java jar-archive, HP dlf, among others. A composite document may be a document-based proposal that includes, for instance, product jpeg-images, a marketing way-clip, a ppt-presentation and an xsl-spreadsheet with financial details. In many instances, multiple workflow participants contribute to different parts of composite documents with different access levels or rights. For instance, publicly posted composite documents (PPCD), which can be relatively large compared to other documents (e.g., consisting of multiple office documents, tables, figures, spreadsheets, etc.) can be exchanged through such low-security communication mechanisms. User errors, transmission channel faults, and/or security attacks may result in a premature workflow termination (e.g., non-compliance with forwarding instructions, corruption of document content resulting in delivery in non-authentic form, etc.) that is silent at either end of the communication pathway (e.g., for the sending participant and/or the receiving participant) and/or an intermediary party (e.g., a document master) having responsibilities for facilitating and/or recording such exchanges.

Document (e.g., PPCD) management and control of document propagation was addressed by introducing various randomly generated nonces and/or complementary workflow assurance tokens in U.S. patent application Ser. No. 13/017,032, filed Jan. 30, 2011 (H. Balinsky, S. Simske “Document Management System and Method). These randomly generated nonces and/or complementary workflow assurance tokens may be transferred over the same communication mechanisms (e.g., channels) by which the document was originally transferred to verify receipt of the document, thus involving the workflow participants in actively sending and/or receiving these randomly generated nonces and/or complementary workflow assurance tokens. Moreover, such exchanges may rely on the same communication mechanism or mechanisms that, for instance, resulted in the document not being delivered to an intended recipient and/or being delivered to the intended recipient but in non-authentic form, thus being discarded (e.g., automatically) on receipt.

Direct messaging can enable verification of receipt and/or access—or non-receipt and/or non-access—by an intended recipient of a particular document (e.g., a PPCD) by a second communication mechanism (e.g., channel) that is separate and/or independent from the first communication mechanism by which the document was sent. The first communication mechanisms by which the document was sent may, for example, be subject to user errors, transmission channel faults, and/or security attacks, etc. Hence, notification of document receipt and/or access—or non-receipt and/or non-access—by an intended receiving participant can be sent via a direct message (e.g., an Internet instant message, a short message service (SMS) message, or a clientless or embedded mobile instant message (MIM), among other mechanisms for sending direct messages) to a sending participant and/or a document master that is sent via the second communication mechanism (e.g., channel) that is separate and/or independent from the first communication mechanism.

In various examples, sending, extracting, transmitting, receiving and/or accessing of the document, the confirmation token, and/or the direct message can be influenced by, effectuated by, and/or dependent upon various factors. For example, the sending, extracting, transmitting, receiving and/or accessing of the document, the confirmation token, and/or the direct message can be dependent upon biometric input (e.g., a fingerprint, a retina scan, entry of user-specific information, such as a birth date, a mother's maiden name, a favorite color, etc., among other identity confirmation indicators). In various examples, applications and/or document handling tools (e.g., software, hardware, firmware, etc.) can determine (e.g., automatically and/or semi-automatically after user acknowledgement) a second communication mechanism that is relatively more accessible, faster, more reliable, etc., in a particular ambience (e.g., environment, locality, etc.) for sending the direct message. In some examples, determination of the particular ambience (e.g., environment, locality, etc.) can be based at least partially upon global positioning system (GPS) input. In some examples, the sending, extracting, transmitting, receiving and/or accessing the document, the confirmation token, and/or the direct message can be dependent upon the GPS locations of one or more of the participants (e.g., the sender, receiver, and/or the document master, etc., as described herein). In some examples, the biometric-based, ambience-based, and/or GPS-based inputs can be at least one transaction identification indicator of the document that is extracted when the document is received and/or accessed by a receiving participant.

As described herein, a workflow can be monitored through direct integration of the applications and/or document handling tools (e.g., software, hardware, firmware, etc.) with direct messaging, allowing for sending and/or receiving (e.g., automatically) of confirmation tokens (e.g., as a “tweet”, among other short messages). In various examples, when a participant receives and/or accesses a document a confirmation token can be recovered and/or derived (e.g., automatically) from a map-file associated with the document (e.g., the map-file being an entry into a PPCD serialized into a single file) and a corresponding confirmation token can be sent back to the previous workflow participant/document master. In various examples, the applications and/or document handling tools can be encoded with instructions that enable automatically extracting and/or transmission of confirmation tokens (e.g., among other operations for extracting, handling, forwarding, etc., the information and/or data described herein) upon receipt of and/or accessing (e.g., opening) the document. Alternatively or in addition, the extracting and/or transmission of confirmation tokens (e.g., among the other operations for extracting, handling, forwarding, etc., the information and/or data described herein) can be semi-automatic upon receipt of and/or accessing (e.g., opening) the document (e.g., following acknowledgement by a recipient, for example, by clicking a specific button on a user interface). Because some documents, such as a PPCD, are too large to be sent over direct messaging communication mechanisms (e.g., channels), there is guaranteed separation between the communication mechanisms, which can enable PPCD propagation using independent channels for distribution and monitoring, which are unlikely to experience difficulties simultaneously.

Systems, computer readable media, and methods for workflow monitoring of documents are provided. An example of a workflow monitoring system includes a document having a map-file for each participant in a workflow of the document and a first communication mechanism to transmit the document to a receiving participant in the workflow. The system includes an application (e.g., software, hardware, firmware, etc.), associated with a receiving device (e.g., a server, a desktop and/or laptop personal computing apparatus, a mobile communication apparatus, etc.) of the receiving participant, to extract (e.g., automatically) a confirmation token from the map-file and enable (e.g., automatically) transmission of the confirmation token and a second communication mechanism, different from the first communication mechanism, to transmit a direct message including at least the confirmation token to verify receipt of the document by the receiving participant.

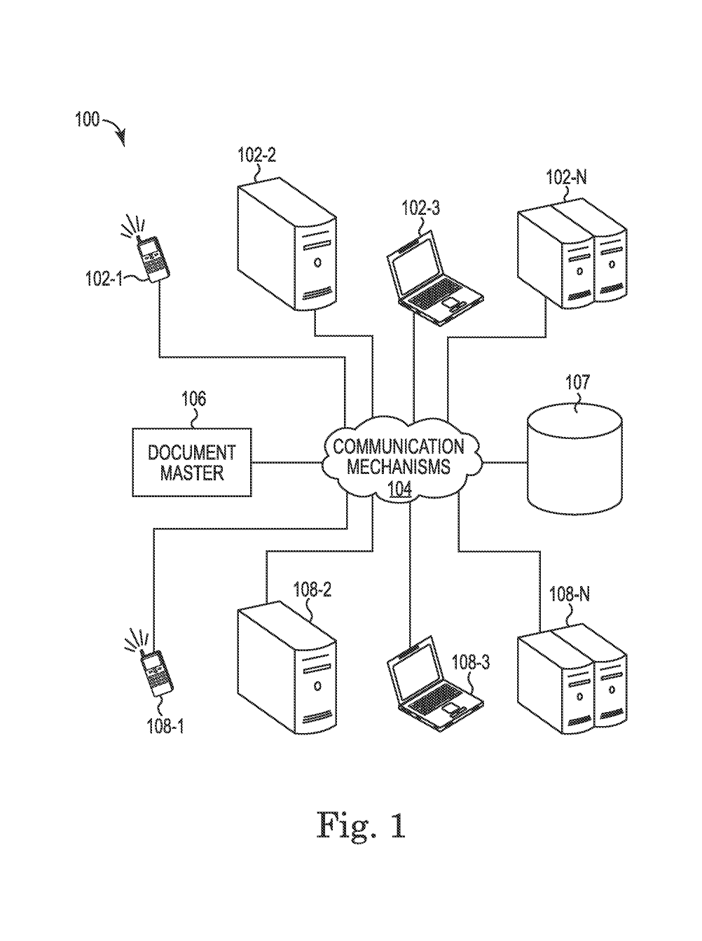

FIG. 1 illustrates an environment in which various examples of workflow monitoring in accordance with the present disclosure may be implemented. FIG. 1 shows the environment 100 to include a number of participant sending devices 102-1, . . . , 102-M for documents. By way of example and not by way of limitation, such sending devices can include a number of mobile communication apparatuses 102-1 (e.g., a cell phone, a smart phone, etc.), a desktop personal and/or business computing apparatus 102-2, laptop computing apparatuses 102-3, and/or servers 102-M, among other sending devices enabled by computing apparatuses. Each of the participant sending devices 102-1, . . . , 102-M can be directly or indirectly coupled to a number of communication mechanisms 104, as described herein, a document master 106, and/or a data store 107 having memory and processing resources for data (e.g., documents). In some examples, the document master 106 can be and/or can be operatively interfaced with the data store 107.

In the detailed description of the present disclosure, reference is made to the accompanying drawings that form a part hereof and in which is shown by way of illustration how examples of the disclosure may be practiced. These examples are described in sufficient detail to enable those of ordinary skill in the art to practice the examples of this disclosure and it is to be understood that other examples may be utilized and that process, electrical, and/or structural changes may be made without departing from the scope of the present disclosure. Further, where appropriate, as used herein, “for example’ and “by way of example” should be understood as abbreviations for “by way of example and not by way of limitation”. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

FIG. 1 shows the environment 100 to include a number of participant receiving devices 108-1, . . . , 108-N for documents. Similar to the sending devices, such receiving devices can include a number of mobile communication apparatuses 108-1, desktop personal and/or business computing apparatuses 108-2, laptop computing apparatuses 108-3, and/or servers 108-N, among other receiving devices enabled by computing apparatuses. Each of the participant sending devices 108-1, . . . , 108-N can be directly or indirectly coupled to the number of communication mechanisms 104, as described herein, the document master 106, and/or the data store 107 having memory and processing resources for data (e.g., documents).

In various examples, depending upon which direction a document is being sent between two participants (e.g., neighboring participants) among a group of interacting participants, the sending devices 102-1, . . . , 102-M can function as receiving devices and the receiving devices 108-1, . . . , 108-N can function as sending devices. Servers 102-M, 108-N can also function as computing devices configured to respond to network requests received from client devices 102-1, 102-2, 102-3, 108-1, 108-2, 108-3. Servers 102-M, 108-N may include web servers, application servers, and/or data servers. Servers 102-M, 108-N may also include intermediate proxies, routers, switches, load balancers, and the like. Client devices 102-1, 102-2, 102-3, 108-1, 108-2, 108-3 can represent any computing apparatuses configured with browsers, data processing, word processing, and/or other applications to communicate (e.g., send or receive) requests and/or process corresponding responses relating to documents (e.g., applications can be configured to extract usable data from map-files, as described herein).

The communication mechanisms 104 represent a first communication mechanism by which a document is sent (e.g., transmitted/transferred by e-mail, cloud-based access, service- or shared-point access, being uploaded and/or downloaded, exchange of a CD and/or a DVD, through a USB and/or a shared drive, etc.) and a second communication mechanism by which notification of document receipt and/or access—or non-receipt and/or non-access—by an intended receiving participant can be sent via a direct message (e.g., an Internet instant message, a SMS message, or a clientless or embedded MIM) to a sending participant and/or a document master. As described herein, the first communication mechanism and the second communication mechanism each are separate from each other and are unaffected by operational status of the other communication mechanism. For example, the first communication mechanism and the second communication mechanism can be independently secured, validated, etc., and/or they can operate on completely different, independent media, as described herein. Cable, wireless, fiber optic, and/or remote connections via a telecommunication link, an infrared link, a radio frequency link, or any other connectors or systems can provide electronic communication between the sending and/or receiving devices 102, 108 of the sending and/or receiving participants, the document master 106, and/or the data store 107.

The present disclosure provides a separate mechanism for document propagation confirmation and acknowledgement. Sending a confirmation token over a same or similar communication mechanism (e.g., channel) as a document was sent may be difficult to effectuate as an automatic or semi-automatic response, in particular if the document is a PPCD transmitted/transferred by e-mail, cloud-based access, service- or shared-point access, being uploaded and/or downloaded, exchange of a CD and/or a DVD, through a USB and/or a shared drive, etc. In addition, using the same or similar channels for a document and its confirmation token, which provides verification of propagation, can reduce confidence in veracity of lack of such verification due to a lack of reliability and/or security of the communication mechanism itself.

Direct messaging can be a more reliable and/or secure communication mechanism. For example, Internet messaging (e.g., Twitter) can be text messaging on the Internet. The size of such a text message (e.g., a “tweet” limited to 140 characters), or of a few such text messages, is sufficient to pass a confirmation (e.g., a confirmation token) of a document (e.g., a PPCD) propagating along its workflow. In various examples, such direct messaging (e.g., Internet messages, among others) can be generated and sent (e.g., automatically) by an application (e.g., software, hardware, firmware, etc.), associated with a receiving device. In some examples, such Internet messaging can be sent without recourse to mobile networks (e.g., operated by commercial communication entities, etc.), unlike mobile messages sent by cell phones, smart phones, etc. As such, in some examples, direct messages can be sent without reliance on a fee-based service.

A document master 106 can utilize, for example, an Internet messaging account (e.g., Twitter, among others) to control and/or monitor a plurality of document (e.g., PPCD) workflows. Alternatively, the document master 106 can create a new account for each document workflow. Some or all document (e.g., PPCD) workflow participants can become “followers” of the document master 106, depending upon whether each participant desires updates on propagation of the workflow. The document master 106 may in turn become a “follower” of some or all workflow participants, thus allowing the document master 106 to confirm and/or verify (e.g., tweet) with the confirmation token, which can be accompanied by document identification information (e.g., a shipment transaction ID) and/or other pertinent information relating to the document. Information such as the confirmation token, the document identification information, and/or other pertinent information, as described herein, can, for example, be extracted, generated, and/or derived (e.g., based upon information included and/or encoded in the map-file of the document) when the corresponding document is received by a receiving participant's receiving device and/or when accessed (e.g., opened with or without active instruction by the receiving participant).

Hence, the present disclosure enables monitoring (e.g., automatically) of workflow progress and/or propagation, which can occur without active participation of workflow participants. For example, when a workflow participant receives and/or accesses a document, the application and/or the document handling tool (e.g., software, hardware, firmware, etc.) associated with the receiving device can send (e.g., automatically) a direct message to the previous workflow participant, the document master, and/or an automated workflow monitoring and documentation entity of the document master. The previous workflow participant and/or the document master (e.g., an application and/or a document handling tool associated with the sending device and/or a receiving/sending/data storage device of the document master) can expect this direct message, for example, for a defined period of time after the document was sent. If the direct message with the corresponding confirmation token does not arrive within the defined period of time, the previous participant and/or the document master (e.g., the application and/or the document handling tool associated with the sending device and/or the receiving/sending/data storage device of the document master) can resend (e.g., automatically) the document (e.g., via the first communication mechanism) and/or can alert (e.g., automatically) the document master, the previous workflow participant, another neighboring participant, and/or the subsequent workflow participant (e.g., the intended receiving participant) using a direct message.

In some examples, when a document is received and/or accessed, a workflow participant (e.g., the application and/or the document handling tool associated with the receiving device) can send (e.g., automatically) a direct message to the document master without sending a direct message to the previous participant. In some examples, the document master (e.g., the application and/or the document handling tool associated with the receiving/sending/data storage device of the document master) can relay (e.g., automatically) the direct message to the previous workflow participant, thus confirming and/or verifying successful document propagation.

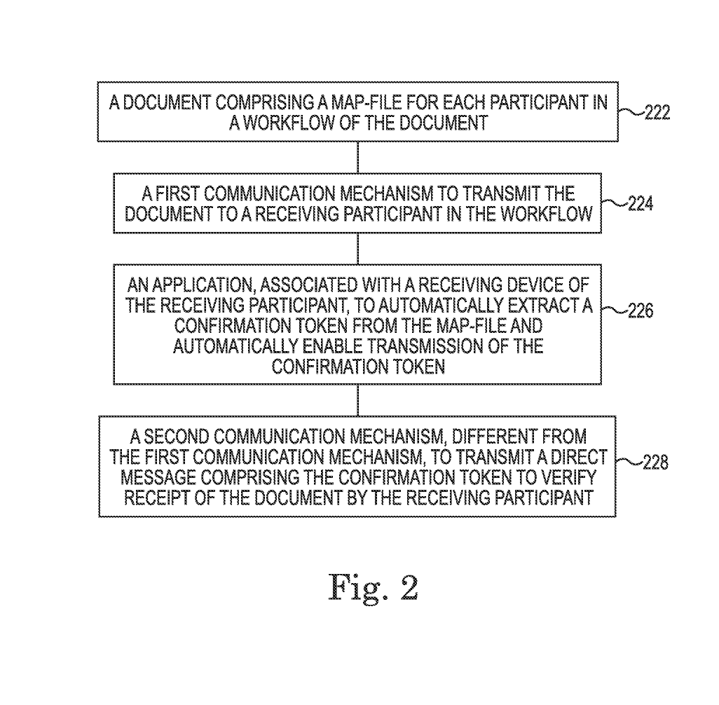

FIG. 2 is a block diagram of a system for workflow monitoring according to the present disclosure. As shown in box 222, a workflow monitoring system can include a document comprising a map-file for each participant in a workflow of the document. That is, in various examples, each document (e.g., PPCDs) can have a map-file attached thereto and/or embedded therein that includes a subset of access keys to document parts corresponding to access rights to each of the particular document parts granted to each of a group of potential participants. As described herein, in various examples, the map-file can include a confirmation token. Each map-file can be encrypted and/or signed for by each participant individually when accessing the document.

The workflow monitoring system can include a first communication mechanism, as described herein, to transmit the document to a receiving participant in the workflow, as shown in box 224. The system can include an application, as described herein, associated with a receiving device of the receiving participant, to extract (e.g., automatically) a confirmation token from the map-file and enable (e.g., automatically) transmission of the confirmation token, as shown in box 226. The workflow monitoring system can further include a second communication mechanism, as described herein, different from the first communication mechanism, to transmit a direct message comprising the confirmation token to verify receipt of the document by the receiving participant, as shown in box 228.

As described herein, in various examples, the first communication mechanism can be selected as one or more communication mechanisms from e-mail, Internet access, a cloud network, a CD, a DVD, a USB, and/or a shared drive, among other equivalent communication mechanisms. In contrast, the second communication mechanism, which has an individual message size capacity too small to transmit the document to the receiving participant, transmits the direct message via one or more communication mechanisms selected from an Internet instant message, a SMS message, or a clientless or embedded MIM, among other equivalent communication mechanisms. In various examples, the confirmation token to verify receipt of the document by the receiving participant can be transmitted (e.g., as content in the direct message) to a sending participant, another neighboring participant, and/or a document master.

In some examples, the confirmation token can include or be linked to a transaction identification indicator of the document extracted when the document is accessed by the receiving participant and/or the application and/or the document handling tool associated with the receiving device. Accordingly, in some examples, the confirmation token and the transaction identification indicator can be transmitted (e.g., as content in the direct message) to the sending participant, another neighboring participant, and/or the document master.

Workflow monitoring can, as disclosed herein, be utilized in a document management system used to document, monitor, and/or ensure that documents (e.g., PPCDs) are propagated along their workflows. In particular, the system may be used to ensure that a workflow is not silently terminated prior to its completion (e.g., due to a recipient never receiving a document, a document being discarded as spam, a document being sent to an unintended recipient, a recipient being unavailable, among other reasons, for example, related to improper biometric-based, ambience-based, and/or GPS-based inputs). The system can enable failures in a workflow to be detected, for example, by alerting a current workflow participant that the document was not delivered to the next participant. The system can also enable failures to be logged and/or reported to a document workflow master or administrator (e.g., collectively termed a document master), which can increase assurance that the document actually moves along the workflow according to specified constraints and/or instructions.

As utilized herein, the term “workflow” refers to a defined set of stages, usually with a defined set of tasks at each stage, through which a document passes during its propagation lifecycle. A composite document, such as a PPCD, is a document including several items (e.g., a number of Portable Document Formats (PDFs), Power Point files (PPTs), Microsoft Word documents (DOCs), and/or Microsoft Excel spreadsheet, among many other types). In various examples, the workflow can be an automated process during which documents, information, and/or tasks are passed from one participant to another for action and/or informative purposes, according to a set of procedural rules. Workflows can include imaging workflows (e.g., quality assurance, authentication, forensics, among others), supply chain workflows (e.g., track and trace, inspection, shipping/receiving, recall, among others), environmental or sensor data monitoring workflows, and/or other types of usable workflows (e.g., statistics, inventory, compliance, and/or auditing, among others). That is, a workflow can be any defined set of tasks to complete that is associated with a document to be transferred amongst a group of participants.

A workflow may involve numerous participants, many or all of whom may not know all of the other participants. As described herein, a document (e.g., a PPCD) that is the subject of the workflow may be transferred between workflow participants by any of a number of available and suitable communication mechanisms (e.g., channels) for transfer of such documents, including, for example, e-mail, any publicly shared memory device (e.g., CD, a DVD, a USB key, etc.), public posting systems (e.g., the Internet, cloud computing systems, etc.) where documents may be uploaded and downloaded, file sharing systems (e.g., service- or shared-point access systems such as SharePoint, etc.), or the like.

Each workflow participant can be provided with, for example, an entire PPCD, although one or more parts of the composite document may be accessible for reading only, accessible for reading and writing, or not accessible for reading or writing to a particular participant, among other granted access rights (e.g., as defined in the map-file). It may be desirable to provide the entire composite document during the workflow because particular later participants in the workflow may have access rights to parts of the document to which an earlier workflow participant did not have access rights.

As described herein, a composite document can include: individual content items or parts, each of which can consist of multiple individual files and fragments; one or more map-files for each participant in the workflow, each map-file providing differential access for the respective participants; and, in some instances, an entry table, which is a fast filtration mechanism to identify a participant's map-file without exposing the participant's identity. In some examples, a participant may identify his/her map-file(s) within a document using the entry-table, which can utilize encrypting a small known string of characters for each workflow participant. Each participant can attempt to decrypt the strings until the correctly decrypted string is found.

In order to provide controlled differential access to a content part, the part can be encrypted by its own specifically-generated and assigned encryption key Eᵢ, where the subscript i specifies a part number (e.g., in a PPCD). An extra pair of keys for each part can be provided, namely a signature key Sᵢ and a signature verification key Vᵢ. The access control for a composite document part can thus be enabled by 4 keys: {{Eᵢ, Dᵢ}, {Sᵢ, Vᵢ}}, where Dᵢ is the decryption key. Read only access can be controlled by having or not having decryption key Dᵢ. Read and write access can require three keys Eᵢ, Dᵢ, Sᵢ. An item can be decrypted using Dᵢ, modified as needed, encrypted using E_{i/p} and then signed using Sᵢ. A workflow participant without any granted access to a content part can be given a signature verification key Vᵢ that will allow the participant to validate authenticity of the item (e.g., when the participant has validated access).

As such, every item and/or part of a composite document can be signed by its own signature key Sᵢ and every workflow participant can be securely given the corresponding signature verification key Vᵢ for each item/part, irrespective of the type of granted access. Upon reception, it may be mandatory that every workflow participant verifies the signature of every item/part using the corresponding signature verification key Vᵢ. Participants can access for reading only those parts for which they are given the corresponding decryption key Dᵢ and can modify only those parts for which they are given Eᵢ, Dᵢ, Sᵢ in addition to Vᵢ. The participant can use Eᵢ to encrypt modified contents and generate a new signature using Sᵢ, which is validated by a subsequent workflow participant.

In the examples disclosed herein, a confirmation token to confirm and/or verify delivery, receipt, and/or access to the document is also included (in addition to the previously mentioned keys) to address, for example, the problem of premature silent workflow termination. In one example, the confirmation token can include corresponding, randomly generated nonces within the respective map-files of neighboring participants. A random number generator of the document management system can generate the corresponding nonces (e.g., a random binary string), which can then distributed within the respective map-files of neighboring participants. Randomly generated corresponding nonces can, in various examples, function as a shared secret between neighboring participants and can be used to verify that the composite document has been received and/or accessed by the next participant or participants in the workflow.

Alternatively or in addition, a confirmation token can, in various examples, include one-time complementary workflow assurance tokens within the respective map-files of neighboring participants. A secure controller of the document management system can generate specific keys (as discussed further herein), which can be distributed within the respective map-files of neighboring participants. These keys may be used to generate a digital signature and/or to verify the digital signature. This approach indicates to the sender that the document was received as it was sent, as well as that it was received, by the correct workflow participant. In some examples, the document can include both the randomly generated nonces and the one-time complementary workflow assurance tokens as the confirmation tokens.

As used herein, “neighboring participants” are workflow participants who work on or access the document in a sequential manner. For example, participant i may work on the document and upload the document to a cloud computing system, and participant i+1 may subsequently download the document from the cloud computing system and work with and/or modify the document. In another instance, participant i may e-mail, post on CD/DVD, etc., the document to participant i+1. Participants i and i+1 are thus neighboring participants in the workflow. In some examples, one of the neighboring participants is a sender of the document and the other of the neighboring participants is a receiver of the document. Neighboring participants may include multiple receivers. This can occur when there is a split in the workflow and multiple participants are accessing the document in any order after it is released (e.g., transmitted) by the sender (e.g., participant A sends the document to participant B, and then participants C, D, and E can receive and/or access the document in any order once the document is released by participant B).

An example of document management can include a number generator that distributes corresponding, randomly generated nonces within the respective map-files of the neighboring participants and/or a secure controller application that distributes complementary workflow confirmation tokens within the respective map-files of the neighboring participants. The document can be received at a receiving one of the neighboring participants and the participant (e.g., the application and/or the document handling tool associated with the receiving device) can recover (e.g., automatically extract) the respective corresponding, randomly generated nonce of the receiving one of the neighboring participants and/or the respective complementary workflow confirmation token of the receiving one of the neighboring participants, and transmit the recovered corresponding, randomly generated nonce of the receiving one of the neighboring participants, a signature generated by the receiving one of the neighboring participants, and/or the respective complementary workflow confirmation token to a sending one of the neighboring participants for verification of receipt of and/or access to the document.

In various examples, any randomly generated nonce may be utilized. The randomly generated nonces in the neighboring map-files may be matching (e.g., identical) or complementary. The randomly generated nonces may, in some examples, be used once and not be repeatedly used between various workflow steps and/or documents. As such, a first set of neighboring participants can share the first randomly generated nonce and a second set of neighboring participants can share the second randomly generated nonce, which is different from the first randomly generated nonce. For example, once the randomly generated nonce is generated for workflow step i and given to i participant and his neighboring participant i+1, the randomly generated nonce is not reused.

One example of nonces (Nᵢ₋₁, Nᵢ, Nᵢ₊₁) distributed in the corresponding map-files of a composite document is illustrated as follows:

(i−1) participant map-file
<shipment_nonce=“Nᵢ confirmation_verification_key=“Vᵢ₋₁”>
(i) participant map-file
<reception_nonce=“Nᵢ₋₁” confirmation_signature_key=“Sᵢ₋₁”>
<shipment_nonce=“Nᵢ” confirmation_verification_key=“Vᵢ”>
(i+1) participant map-file
<reception_nonce=“Nᵢ” confirmation_signature_key=“Sᵢ”>
<shipment_nonce=“Nᵢ₊₁” confirmation_verification_key=“Vᵢ₊₁”>

In various examples, multiple different corresponding nonces may be simultaneously managed for splits in the workflow. For example, if there are multiple i+1 participants (e.g., i+1_{A}, i+1_{B}, etc.), the map-file for i may include a nonce for each of the i+1 participants. The sender can verify whether a received nonce matches one of the randomly generated nonces.

When a receiving participant obtains the document containing the nonce, the participant (e.g., the application and/or the document handling tool associated with the receiving device) will be able to access the nonce in his/her map-file, which can, in some examples, be decrypted using a private decryption key that is supplied to that participant through his/her entry table. For example, a process preceding the participant accessing the nonce can occur as follows. The receiving participant can use his/her private decryption key to identify his/her corresponding entry in the entry table. From this entry, the participant can recover his/her map-file name and map-file decryption key generated for this participant for this workflow step. Once the map-file is identified and decrypted, the nonce that is the workflow token can be recovered and sent to the previous participant (e.g., the sender).

In the examples disclosed herein, in addition to or instead of nonces, complementary workflow confirmation tokens (e.g., pairs of specifically generated verification and/or signature keys (e.g., Vᵢ and Sᵢ) may be distributed for pairs of sequential workflow participants (i.e., neighboring participants). These can be one-time signature and verification keys generated for the sender-receiver pair by a secure controller of an authoring tool (as described herein). The signature verification key (e.g., Vᵢ₋₁) from each pair can be provided to the sender (e.g., i−1) via his/her map-file and the corresponding signature key (e.g., Sᵢ₋₁) can be provided to the receiver (e.g., i) via his/her map-file. All of these keys can be provided within corresponding map-files for each workflow participant. Each map-file also can be individually encrypted and/or signed, and can only be accessed by the corresponding workflow participant at the corresponding step (e.g., via the application and/or the document handling tool associated with the sending/receiving device). Thus, only the correct document receiver may recover the signature key that corresponds to the verification key currently held by the sender.

Once the receiver recovers (e.g., extracts) this signature key from his/her map-file, he/she can generate the signature of the original version of the received document. The receiver can then send this signature back to the sender. The sender can verify the received signature for this document using a corresponding signature verification key, his/her retained copy of the document (i.e., the version of the document just prior to being sent), and the received signature. If the signature is verified, the sender can finish the transaction by confirming that the document as sent was delivered to the valid workflow participant, as only a valid workflow participant is able to create the verified signature. “Signature”, in these examples, can refer to the standard Digital Signature (e.g., DSA).

In some examples, the nonce can be used to contribute to confirmation that the document has been received by the valid workflow participant, who in turn verified the document, recovered his/her nonce, and sent it to the previous workflow participant. The nonce may also be sent directly to the document master or any other workflow watching service to contribute to confirmation that the document has, in fact, propagated to the next workflow participant. In some examples, the complementary workflow confirmation tokens (e.g., the specifically generated verification and signature keys) may be used to generate the full document signature, which can be sent back and then verified by the previous workflow participant. In this example, the specifically generated one-time signature key given to the receiver within his/her map-file can be used to sign the current version of the document. The receiving participant can then send the generated signature back to the sending participant.

Since the sending participant may originally be unknown to the receiving participant, the nonce or signature can be publicly posted to the receiving participant (e.g., in the map-file and/or in the document) using any public communication mechanism (e.g., channel) associated with the system (e.g., the first communication mechanisms as described herein). That is, the workflow participants have access to some communication channel that allows them to send the document and send the nonce or signature in the desired direction. However, in accordance with the present disclosure, the confirmation token (e.g., which may be accompanied by the nonce and/or the signature or may be the nonce and/or the signature) is sent to the sending participant and/or the document master via the second communication mechanism, as described herein.

Workflow monitoring can involve verification at each step in the process, and each participant in the workflow can be alerted to the fact that verification is required. As such, after sending the document, the sending participant will know to watch for adequate confirmation as required by the workflow (e.g., the nonce, the signature, and/or the confirmation token). That is, the receiving participant does not post or send the entire document with the nonce, the signature, and/or confirmation token because the sending participant already has an authentic version of the document

If the sending participant does not receive the nonce, the signature, and/or the confirmation token within a particular (e.g., predetermined) amount of time, the sending participant (e.g., the application and/or the document handling tool associated with the sending device) can attempt to resend the document, contact the next workflow participant by another communication mechanism (e.g., channel), and/or inform the document master that he/she is unable to transfer the document to the next workflow participant. When a transmission to a receiving participant fails, the nonce, the signature, and/or the confirmation token remain secret because they can only be decoded using the decryption key known by the corresponding workflow participants. As such, the transmission of the document may be attempted one or more additional times to ensure that the document has actually been sent, received, and/or accessed. Similarly, if the return communication to the sending participant (e.g., from the receiving participant) fails, then the nonce, the signature, and/or the confirmation token may be sent any number of times because the document has already been received by the valid workflow participant.

When either the nonce, the signature, and/or the confirmation token is transmitted back to the sending participant, upon receipt the sending participant can compare the received nonce, the signature, and/or the confirmation token with the nonce, the signature, and/or the confirmation token retrieved from his/her map-file for this workflow step. If the nonce, the signature, and/or the confirmation token are matching, the sending participant can verify that the workflow properly propagated. When the signature is transmitted back to the sending participant, upon receiving the signature, the sending participant can use his/her signature verification key. The sending participant can receive the document signature from the next participant and can use his/her signature verification key to verify the received signature.

In various examples, the receiving participant can then become a sending participant. The receiving participant can perform his/her workflow tasks and send the document to the next participant(s). Since this is a different step in the workflow, the randomly generated nonce and/or the confirmation token is particular to these neighboring participants and is not a replicate of the earlier randomly generated nonce and/or confirmation token.

The system can distribute all or some of the nonces, signatures, confirmation tokens, and/or verification keys within the encrypted map-files at the outset of the workflow or add them during propagation of the document. For example, when the identities and/or the number of workflow participants is known, the number generator can assign randomly generated complementary nonces and/or the secure controller application can assign confirmation tokens to each of the known map-files at an initiation of the workflow.

As the document propagates through the workflow, the verification of nonces, signatures, and/or confirmation tokens sent from one participant to the next enables the system to keep track of the document's progress. Since the receiving participant's transmission of either the nonces, signatures, and/or confirmation tokens in a direct message can be automatic, the system can recognize when a nonce, signature, and/or a confirmation token has not been verified.

In some examples, each workflow step is or some of the workflow steps are to be accomplished or completed by preset deadlines, and the nonce, signature, and/or confirmation token verification is to take place within the particular (e.g., predetermined) amount of time before expiration of this deadline. For example, the system can be programmed to recognize the expiration of the preset deadline and/or a preset amount of time after the document was sent. Not verifying with the nonce, signature, and/or confirmation token before expiration of the preset deadline and/or within the preset amount of time can trigger the system to generate a direct message (e.g., an alert) for the document master that identifies where in the workflow interruption of the propagation has taken place.

The system disclosed herein can, in various examples, include generating a traceable and verifiable log within the document. The document log may provide a historical confirmation for the document propagation (e.g., transitions between participants), which may be verified by subsequent audit. In various examples, the log can be a record of the transmitted nonces, signatures, and/or confirmation tokens, along with the corresponding version of the document. In some examples, the log can be a record of the nonces, signatures, and/or confirmation tokens, along with a trimmed version of the document (e.g., a document constant part that does not change along the workflow, such as map-files and/or entry tables) such that, for example, the signatures can be verified at a later date. In some examples, the log can be a record of nonces and/or confirmation tokens that have been signed, either with or without a secure timestamp.

The transmission of nonces, signatures, and/or confirmation tokens indicates to the system that the receiving participant was able to access the nonces, signatures, and/or confirmation tokens. The system can create (e.g., automatically) an entry in a document log identifying the nonce, signature, and/or confirmation token transmission. This type of entry can indicate that the document was received and that a nonce, confirmation token, and/or full document signature was obtained from those distributed within a particular participant's map-file. Multiple entries in the log indicate that the document is propagating along its workflow. Any entry into the document log may be associated with a timestamp. In some examples, the information in the log entry of the current document can only be put therein by the document receiver, as he/she now holds the latest version of the document. As such, some log entries may require an extra transfer of confirmation information from the sender back to the receiver.

A full or partial document signature scheme can be deployed to record document propagation. As previously stated, in some examples, a pair of signature and verification keys (e.g., Vᵢ and Sᵢ) can be generated for each sender-receiver pair, and the sender can be provided with the signature verification key from this pair and the receiver can be provided with the signature key from this pair. Depending on the particular workflow, the sender may be asked to sign the entire document or its constant part (e.g., map-files and/or entry tables). In some workflows, the receiver might be asked to generate both signatures (i.e., the full signature and the constant part signature). Both signatures could be verified by the sender. The signature of the constant part may be placed by the receiver into the document log file, where it can be used for a future document history audit. This is due to the document constant part remaining unchanged while the document propagates along its workflow and other parts are being modified. Thus, the sequence of accumulated sequential signatures of the constant part of the document may be verified and audited at later stages (e.g., by the document master). The document log may be used to coordinate a transition to a next stage of the workflow and/or to set characteristics and/or settings of the next stage of the workflow.

As such, a method of workflow monitoring can, in various examples, include placing at least one confirmation token extractable from a map-file for each participant in a workflow of a document. The method can include receiving at least one of the confirmation tokens when extracted by an application associated with a receiving device at a receiving one of the neighboring participants that transmits (e.g., automatically) the confirmation token. The at least one of the confirmation tokens can be received in a direct message from the receiving one of the neighboring participants for verifying receipt of the document, where the direct message is accomplished via a communication mechanism (e.g., the second communication mechanism, as described herein) that is different from a communication mechanism via which the document is distributed (e.g., the first communication mechanism, as described herein).

In various examples, the at least one confirmation token extractable from map-files of the document can be distributed, where the map-files are for neighboring participants in the workflow of the document. In various examples, the direct message can be received by a sending participant, another neighboring participant, and/or a document master via the communication mechanism that is different from the communication mechanism via which the document is distributed. Unless explicitly stated, the method examples described herein are not constrained to a particular order or sequence. Additionally, some of the described method examples, or elements thereof, can occur or be performed at the same, or substantially the same, point in time.

Some examples can include distributing (e.g., automatically) a copy of the document to an intended receiving one of the neighboring participants after a period of time has elapsed without receiving the at least one of the confirmation tokens from the intended receiving one, as executed by an application associated with a sending device. Some examples can include the intended receiving one being notified of an upcoming document transmission (e.g., within a preset time window prior to the document being transmitted) via the second communication mechanism, as executed by an application associated with the sending device. Some examples can include (e.g., automatically) via a direct message any of a sending participant, the intended receiving one of the neighboring participants, another neighboring participant, and/or a document master after a period of time has elapsed without receiving the at least one of the confirmation tokens from the intended receiving one, as executed by an application associated with the sending device. Some examples can include receiving the at least one of the confirmation tokens in a direct message to the document master, the document master forwarding (e.g., automatically) the at least one of the confirmation tokens or an alternative confirmation indicator (e.g., the signature, as described herein) to the sending participant or another neighboring participant for verifying receipt of the document, as executed by an application associated with a document master device, as described herein.

In any of the examples disclosed herein, a number of executables may be embedded into the document and/or the map-file when sending the nonces, signatures, and/or confirmation tokens to the sending recipient. The addition of an executable can depend, at least in part, upon the presence or lack of presence of a service/daemon of the participant device/hardware. In various examples, the executable can be encrypted and/or signed as a content part of the document and/or its map-file, and thus its addition poses no additional security risk.

The document monitoring system disclosed herein can include a secure authoring tool and one or more individual computing systems that perform one or more of the functions disclosed herein. The secure authoring tool can, in some examples, enable the document master to generate the document, the workflow, and the workflow keys, nonces, tokens, etc., that enable documentation of the workflow propagation. A document distribution version can be exported by the secure authoring tool out of a master version of the document. The master version can be retained in the secure location, while the distribution version is transmitted among workflow participants by any available first communication mechanism (e.g., channel).

In various examples, the secure authoring tool can be associated with a first communication mechanism that enables the documents to be uploaded and downloaded, or to be shared via a shared drive or a cloud computing network, as described herein. In this example, a variety of workflow participants can access the documents from individual computers by accessing the shared drive or cloud computing network. The secure authoring tool may also be accessible via the Internet and unassociated with any particular shared drive or cloud computing network. In these instances, documents can be transmitted via publicly shared memory devices (e.g., CDs, DVDs, USBs, etc., or any other suitable channel capable of transmitting the document).

The individual computing systems may be stationary (e.g., desktop computers) or mobile (e.g., laptop computers, netbooks, cellular phones, personal digital assistants (PDAs), etc.). The individual computing systems can run one or more applications that enable the participants to obtain access to individual portions of a composite document according to preset (granted) access rights, and the applications can perform receipt, accessing, decryption, encryption, signature verification, and/or signing functions.

When part of the system, the shared drive or cloud computing network may be associated with a network of interconnected computers and/or other electronic devices (e.g., scanners, printers, etc.), including virtualized and/or redundant processors, banks of processors and/or servers, etc. The components of the shared drive or cloud computing network may be implemented in a consolidated location, or portions of the shared drive or cloud computing network may be implemented at different locations. For example, the shared drive or cloud computing network can be a virtualized bank of computers (e.g., processors and/or servers) that enables Internet-based computing (e.g., through which the secure authoring tool can be accessed). Software and data associated with the shared drive or cloud computing network can be stored on servers and/or associated memory.

Hardware of a shared drive or cloud computing network or individual computing systems can include an electronic processing device, such as, for example, a controller, a micro controller, a microprocessor, a host processor, an application specific integrated circuit (ASIC), and/or a reprogrammable hardware logic device (e.g., a field programmable gate array (FPGA), among others). The electronic processing device may be a processor working in conjunction with a central processing unit (CPU) performing the function of a general-purpose processor. Computer programs and/or software (e.g., non-transitory computer readable code) may be loaded onto one or more of the sub-systems and/or stored in a memory thereof. Such programs and/or software are executable via a processing device.

Accordingly, a non-transitory computer-readable medium with workflow monitoring instructions stored thereon for execution by a processor can be executed to provide a document including at least one map-file for each participant in a workflow of the document and enable a first communication mechanism to transmit the document from a sending participant in the workflow to a receiving participant in the workflow. The instructions can be executed to receive from an application, associated with a receiving device of the receiving participant, a confirmation token that is extracted (e.g., automatically) from the map-file of a receiving participant as a result of access by the receiving device and the confirmation token is transmitted (e.g., automatically). As described herein, access by the receiving device can, in various examples, be conditional upon use of a private key by the receiving participant to enable entry into the document and/or the map-file to extract the confirmation token (among other items described herein). The instructions can be executed to enable receipt via a second communication mechanism, different from the first communication mechanism, of a direct message including at least the confirmation token to verify access of the document by the receiving device of the receiving participant.

In various examples, the direct message including at least the confirmation token to verify access of the document by the receiving device of the receiving participant can be received by a receiving device of the sending participant, another participant (e.g., a neighboring or non-neighboring participant among all participants in the workflow), and/or the document master, including any subsets thereof. In various examples, the received direct message including at least the confirmation token can be transformed (e,g., automatically) into a traceable and verifiable log within the map-file of the document (e.g., by the application and/or the document handling tool associated with the sending/receiving device of the sending participant, the receiving participant, and/or the document master). In various examples, the received direct message including at least the confirmation token can be transformed (e.g., automatically) into an auditable (e.g., a non-refutable) verification of access to the document by the sending device of the sending participant and/or by the sending/receiving device of the receiving participant and/or the document master by entry into a memory log. Such an auditable verification of access to the document can, for example, be used for a future document history audit. The workflow of the document can include a plurality of receiving participants and a respective plurality of corresponding confirmation tokens of the plurality of receiving participants can be recovered along the workflow, where the plurality of recovered corresponding confirmation tokens can be transformed (e.g., automatically) into the auditable verification of access to the document by receiving devices of the plurality of receiving participants for entry into the memory log.

For example, the confirmation token can include confidential keys and/or information available only to the sender and the receiver is able to verify this. Thus, the receiver of the confirmation token can be reassured that the confirmation token came from the correct sender. To make the confirmation token auditable, the confirmation token should be such that a third party (e.g., an auditor) checking the confirmation token recorded by the receiver can confirm that the confirmation token was not created by the receiver. For example, if a confirmation token is a randomly generated nonce placed in the map-files of both the confirmation token sender and the confirmation token receiver, when the receiver receives this confirmation token and compares it with the confirmation token in their own map-file, the receiver can be reassured that the token was sent by the correct sender. To make the confirmation token auditable, the confirmation token sender (e.g., the recipient of the document), or applications and/or document handling tools (e.g., software, hardware, firmware, etc.) on his behalf, determines input (e.g., in the map-file) that only the sender can confirm (e.g., a signature determined by a key known only by the correct sender. This signature can then be sent a token (e.g., along with the confirmation token or in place of the confirmation token). The receiver of this token (e.g., the sending participant, another participant, and/or the document master, including any subsets thereof) can verify this signature and be assured that it was generated by the correct token generator. The token receiver can retain this signature (e.g., in the memory log) for a future audit. To pass an audit, the token receiver produces for the audit the valid signature generated by the correct sender. The auditor checks this signature in the same way as the token receiver earlier.

Examples of the present disclosure can include volatile and/or non-volatile memory apparatuses, systems, and methods, including executable instructions and/or logic to facilitate operating the volatile and/or non-volatile memory apparatuses and systems. Processing resources can include one or more processors able to access data stored in memory to execute the transmissions, actions, functions, etc., as described herein. As used herein, “logic” is an alternative or additional processing resource to execute the transmissions, actions, functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

It is to be understood that the descriptions presented herein have been made in an illustrative manner and not a restrictive manner. Although specific examples for systems, executable instructions, methods, and computing devices have been illustrated and described herein, other equivalent component arrangements, instructions, and/or device logic can be substituted for the specific examples presented herein without departing from the spirit and scope of the present disclosure.

What is claimed:

1. A workflow monitoring system, comprising:
a document comprising a map-file for each participant in a workflow of the document;
a first communication mechanism to transmit the document to a receiving participant in the workflow;
an application, associated with a receiving device of the receiving participant, to extract a confirmation token from the map-file and enable transmission of the confirmation token; and
a second communication mechanism, different from the first communication mechanism, to transmit a direct message comprising the confirmation token to verify receipt of the document by the receiving participant.

2. The system of claim 1, wherein the first communication mechanism is electronic mail, Internet access, a cloud network, a compact disc, a digital versatile disc, a universal serial bus, or a shared drive.

3. The system of claim 1, wherein the second communication mechanism transmits the direct message via an Internet instant message, a short message service message, or a mobile instant message.

4. The system of claim 1, wherein the confirmation token to verify receipt of the document by the receiving participant is transmitted to a sending participant, another neighboring participant, or a document master.

5. The system of claim 1, wherein the confirmation token comprises a transaction identification indicator of the document extracted when the document is received or accessed by the receiving participant.

6. A non-transitory computer-readable medium with workflow monitoring instructions stored thereon for execution by a processor to:
provide a document comprising at least one map-file for each participant in a workflow of the document;
enable a first communication mechanism to transmit the document from a sending participant in the workflow to a receiving participant in the workflow;
receive from an application, associated with a receiving device of the receiving participant, a confirmation token that is extracted from the map-file of a receiving participant as a result of access by the receiving device and the confirmation token is transmitted; and
enable receipt via a second communication mechanism, different from the first communication mechanism, of a direct message comprising the confirmation token to verify access of the document by the receiving device of the receiving participant.

7. The medium of claim 6, wherein the direct message comprising the confirmation token to verify access of the document by the receiving device of the receiving participant is received by a receiving device of a sending participant, another participant, or a document master.

8. The medium of claim 6, wherein the received direct message comprising the confirmation token is transformed into a traceable and verifiable log within the map-file of the document.

9. The medium of claim 6, wherein the received direct message comprising the confirmation token is transformed into an auditable verification of access to the document by a sending device of the sending participant by entry into a memory log.

10. The medium of claim 9, wherein:
the workflow includes a plurality of receiving participants;
a respective plurality of corresponding confirmation tokens of the plurality of receiving participants are recovered along the workflow; and
the plurality of recovered corresponding confirmation tokens is transformed into the auditable verification of access to the document by receiving devices of the plurality of receiving participants for entry into the memory log.

11. A workflow monitoring method, comprising:
placing at least one confirmation token extractable from a map-file for each participant in a workflow of a document;
receiving at least one of the confirmation tokens when extracted by an application associated with a receiving device at a receiving one of neighboring participants that transmits the confirmation token; and
receiving the at least one of the confirmation tokens in a direct message from the receiving one of the neighboring participants for verifying receipt of the document, wherein the direct message is accomplished via a communication mechanism that is different from a communication mechanism via which the document is distributed.

12. The method of claim 11, wherein receiving the at least one of the confirmation tokens for verifying receipt of the document by the receiving one of the neighboring participants comprises receiving the direct message by a sending participant, another neighboring participant, or a document master.

13. The method of claim 12, comprising distributing a copy of the document to an intended receiving one of the neighboring participants after a period of time has elapsed without receiving the at least one of the confirmation tokens from the intended receiving one, as executed by an application associated with a sending device.

14. The method of claim 12, comprising alerting via a direct message any of a sending participant, the intended receiving one of the neighboring participants, another neighboring participant, or a document master after a period of time has elapsed without receiving the at least one of the confirmation tokens from the intended receiving one, as executed by an application associated with a sending device.

15. The method of claim 12, comprising receiving the at least one of the confirmation tokens in a direct message to a document master, the document master forwarding the at least one of the confirmation tokens or an alternative confirmation indicator to a sending participant or another neighboring participant for verifying receipt of the document, as executed by an application associated with a document master device.
